(19) United States
(12) Patent Application Publication
(10) Pub. No.: US 2024/0167443 A1
(43) Pub. Date: May 23, 2024

(54) METHODS AND SYSTEMS FOR MULTI-FUEL ENGINE

(71) Applicant: Transportation IP Holdings, LLC, Norwalk, CT (US)

(72) Inventors: Gregory Wright, Longmont, CO (US); Christopher Homison, Wattsburg, PA (US)

(21) Appl. No.: 18/058,468

(22) Filed: Nov. 23, 2022

(51) Int. Cl. F02M 37/00; F02M 21/02; F17C 1/00

(52) U.S. Cl. CPC F02M 37/0064; F02M 21/0209; F02M 21/0221; F02M 37/007; F02M 37/0082; F02M 37/0088; F17C 1/00; F17C 2205/0149; F17C 2205/0323; F17C 2221/012; F17C 2221/033; F17C 2223/0161; F17C 2227/0337; F17C 2250/03; F17C 2250/0408; F17C 2250/0439; F17C 2250/0452; F17C 2250/061; F17C 2265/066

(57) ABSTRACT

Methods and systems are provided for a multi-fuel fuel system. In one example, a system includes a first fuel arranged in an interior volume of a first tank and a second fuel arranged in an interior volume of a second tank. The second tank is arranged in the interior volume of the first tank and in contact with the first fuel.

### BACKGROUND

### Technical Field

Embodiments of the subject matter disclosed herein relate to a multi-fuel engine, and more specifically, to arrangement of fuel tanks including different types of fuels.

### Discussion of Art

Internal combustion engines may include compression-ignition and/or spark-ignition engines. The engine may combust multiple types of fuel. The engine system may include multiple fuel tanks, each storing a different type of fuel. A mobile asset including the engine may have limited packaging space or complex packaging arrangements.

### BRIEF DESCRIPTION

In one embodiment, a system may include a first fuel arranged in an interior volume of a first tank and a second fuel arranged in an interior volume of a second tank. The second tank is arranged in the interior volume of the first tank and in contact with the first fuel. The first fuel is different than the second fuel with regard to one or more of a carbon-content and a physical state.

### BRIEF DESCRIPTION OF THE DRAWINGS

FIG. 1 shows an example embodiment of a train including a locomotive consist, according to an embodiment of the present disclosure.

FIG. 2. shows a schematic diagram of an example embodiment of a locomotive from FIG. 1 with a multi fuel engine, according to an embodiment of the present disclosure.

FIG. 3 shows an example embodiment of a fuel tender which may be include in the train of FIG. 1, according to an embodiment of the present disclosure.

FIG. 4 shows a detailed view of a fuel system, according to an embodiment of the present disclosure.

FIG. 5 shows a method for determining a condition of a gaseous fuel tank, according to an embodiment of the present disclosure.

FIG. 6 shows a method for controlling gaseous fuel tank refueling conditions based on a liquid fuel level, according to an embodiment of the present disclosure.

FIG. 7 shows an operating sequence illustrating adjustments to a refueling operation of the gaseous fuel tank based on the liquid fuel level.

### DETAILED DESCRIPTION

Embodiments of the invention are disclosed in the following description, and may relate to methods and systems for a multi-fuel system of an internal combustion engine (ICE). The ICE may operate via a combination of different fuels. These fuels may have relatively different amounts of carbon. In one example, the ICE may be a multi-fuel engine configured to combust a plurality of fuels. Each of the plurality of fuels may be stored in separate fuel tanks. In one embodiment, one or more of the fuels and its corresponding fuel tank may be housed in a different fuel tank including a different fuel. In one example, a gaseous fuel tank comprising a gaseous fuel may be arranged within an interior volume of a liquid fuel tank comprising a liquid fuel.

The ICE may combust one or more of gasoline, diesel, hydrogenation-derived renewable diesel (HDRD), alcohol(s), ethers, ammonia, biodiesels, hydrogen, natural gas, kerosene, syn-gas, and the like. The plurality of fuels may include gaseous fuels and liquid fuels, alone or in combination. A substitution rate of a primary fuel of the ICE with a secondary fuel may be determined based on a current engine load. In one embodiment, the substitution rate may correspond to an injection amount of a fuel with a relatively lower carbon content or zero carbon content (e.g., hydrogen gas or ammonia). As the substitution rate increases, the relative proportion of fuel with the lower or zero carbon content increases and the overall amount of carbon content in the combined fuel lowers. Additionally or alternatively, the substitution rate may correspond to an injection amount or delivery of a gaseous fuel relative to a liquid fuel.

In one example, the ICE may combust fuels that include both diesel and hydrogen. During some operating modes, the ICE may combust only diesel, only hydrogen, or a combination thereof (e.g., during first, second, and third conditions, respectively). When hydrogen is provided, operating conditions may be adjusted to promote enhanced combustion of the hydrogen. The engine system may be further configured to combust a mixture of three or more fuels including diesel, hydrogen, and ammonia. Additionally or alternatively, ethanol may be included in the combustion mixture.

In one example, systems and methods for the multi-fuel engine may include combusting a primary fuel in combination with one or more secondary fuels. The multi-fuel engine may be configured to combust the primary fuel alone. During some conditions, the multi-fuel engine may be configured to decrease an amount of primary fuel used via substituting one or more secondary fuels into a combustion mixture. The secondary fuels may include a reduced carbon-content relative to the primary fuel. Additionally or alternatively, the secondary fuels may be less expensive, more available, and/or more efficient relative to the primary fuel. The secondary fuels may vary in ignitibility and burn rate. An ignition timing of the multi-fuel engine may be adjusted in response to the combustion mixture to account for inclusion of the secondary fuels. For example, the ignition timing may be retarded as an amount of hydrogen is increased. As another example, the ignition timing may be advanced as an amount of ammonia is increased. The ignition timing may be further adjusted in this way in response to addition and subtraction of the primary and one or more secondary fuels to the combustion mixture. By doing this, knock and pre-combustion may be mitigated.

Embodiments of the system described herein may include a variety of engine types, and a variety of engine-driven systems. Some of these systems may be stationary, while others may be on semi-mobile or mobile platforms. Semi-mobile platforms may be relocated between operational periods, such as mounted on flatbed trailers. Mobile platforms may include self-propelled vehicles. Such vehicles can include on-road transportation vehicles (e.g., automobiles), mining equipment, marine vessels, aircrafts, rail vehicles, and other off-highway vehicles (OHVs). For clarity of illustration, a rail vehicle such as a locomotive may be provided as an example of a mobile platform. In one example, a vehicle system may include an engine, a turbocharger, an aftertreatment system, a fuel system, and a control system.

The fuels described above may be stored in a multi-fuel fuel system including a first tank and a second tank. The second tank may be housed in an interior volume of the first tank. The second tank may include a second fuel, different than a first fuel of the first tank. The second fuel may include one or more of hydrogen, ammonia, natural gas, a solid fuel, and a cryogenic liquid. The first fuel may include one or more of diesel, methanol, ethanol, other alcohols, dimethyl ether (DME), other ethers, biodiesel, HDRD, syn-gas, etc. In some examples, additional fuel tanks comprising other fuels may be stored in the interior volume of the first tank or separately (e.g., outside) from the first tank.

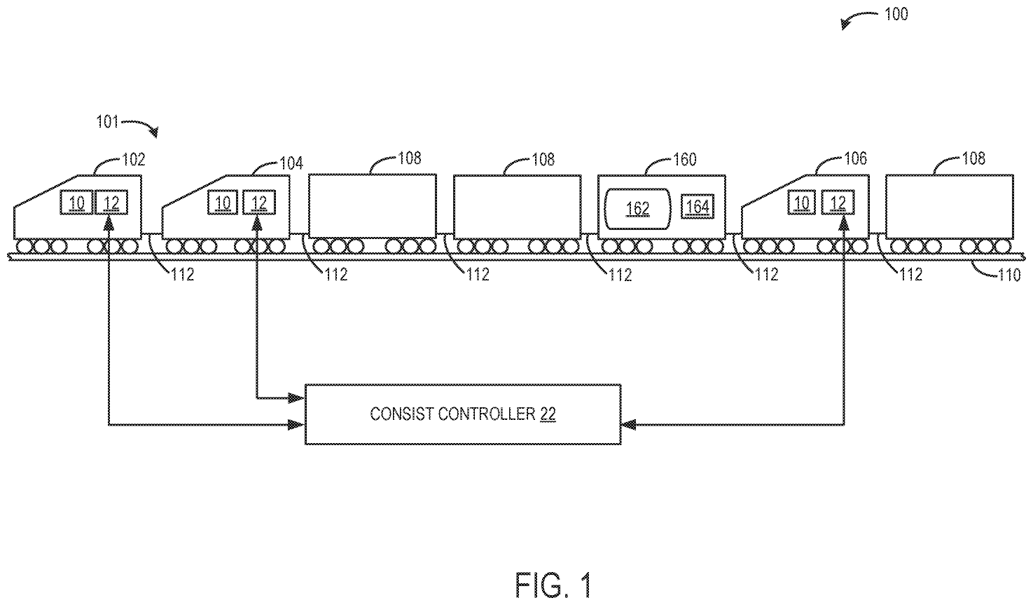

Before further discussion of the system and method for a multi-fuel system, an example platform in which the method and system may be implemented is shown. FIG. 1 depicts an example train 100, including a plurality of rail vehicles, a fuel tender 160, and cars 108, configured to run on track 110. The plurality of rail vehicles, the fuel tender, and the cars are coupled to each other through couplers 112. In one example, the plurality of rail vehicles may be locomotives, including a lead locomotive 102 and one or more remote locomotives 104, 106. While the depicted example shows three locomotives, one fuel tender, and four cars, any appropriate number of locomotives, fuel tenders, and cars may be included in the train. Further, the locomotives in the train may form a consist. For example, in the embodiment depicted, the locomotives may form consist 101. As illustrated, the train includes one consist. However, any appropriate number and arrangement of consists is within the scope of this disclosure. Furthermore, the consist, while depicted with three locomotives in FIG. 1, may include more or less than three locomotives in other examples.

In some examples, the consist may include successive locomotives, e.g., where the locomotives are arranged sequentially without cars positioned in between. In other examples, as illustrated in FIG. 1, the locomotives may be separated by one or more cars in a configuration enabling distributed power operation. In this configuration, throttle and braking commands may be relayed from the lead locomotive to the remote locomotives by a radio link or physical cable, for example.

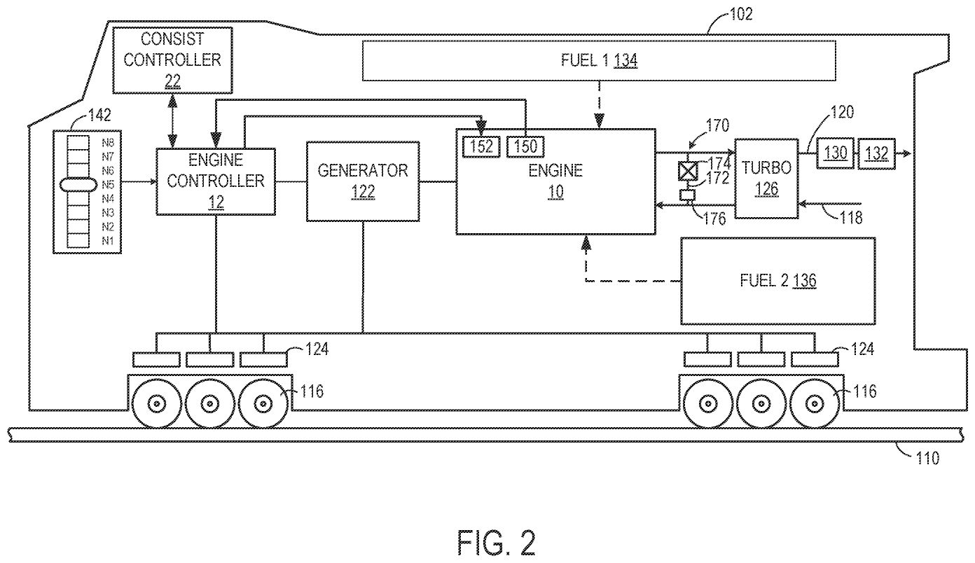

The locomotives may be powered by engine 10, while the cars may be non-powered. In one example, the engine may be a multi-fuel engine. For example, the engine may be configured to combust gaseous and/or liquid fuels with different amounts of carbon, in varying ratios. Further details of the engine are provided further below, with reference to FIG. 2.

The train may further include a control system including at least one engine controller 12 and at least one consist controller 22. As depicted in FIG. 1, each locomotive includes one engine controller, all of which are in communication with the consist controller. The consist controller may be located on one vehicle of the train, such as the lead locomotive, or may be remotely located, for example, at a dispatch center. The consist controller is configured to receive information from, and transmit signals to, each of the locomotives of the consist. For example, the consist controller may receive signals from a variety of sensors on the train and adjust train operations accordingly. The consist controller is also coupled to each engine controller for adjusting engine operations of each locomotive. Each engine controller may determine a current engine condition and adjust a substitution rate thereof. An ignition timing may be adjusted based on the substitution rate. As described above, the substitution rate corresponds to a substitution of a primary fuel with one or more alternative fuels. The engine may be configured to combust with the primary fuel alone. However, during some conditions of the engine, it may be desired to perform multi-fuel combustion to decrease one or more emission types, decrease combustion costs, increase engine efficiency, and accommodate a low availability of one or more fuels. The primary fuel and the alternative fuels may include one or more of gasoline, diesel, hydrogenation-derived renewable diesel (HDRD), alcohol(s), ethers, ammonia, biodiesels, hydrogen, natural gas, kerosene, syn-gas, and the like. Additionally or alternatively, electrical energy may be used to propel the train.

The train may include at least one fuel tender, which may be configured to carry one or more fuel storage tanks 162 and includes a controller 164. While the fuel tender is positioned in front of the remote locomotive 106, other examples may include alternate locations of the fuel tender along the train. For example, the fuel tender may be instead positioned behind the remote locomotive or between the lead locomotive and the remote locomotive.

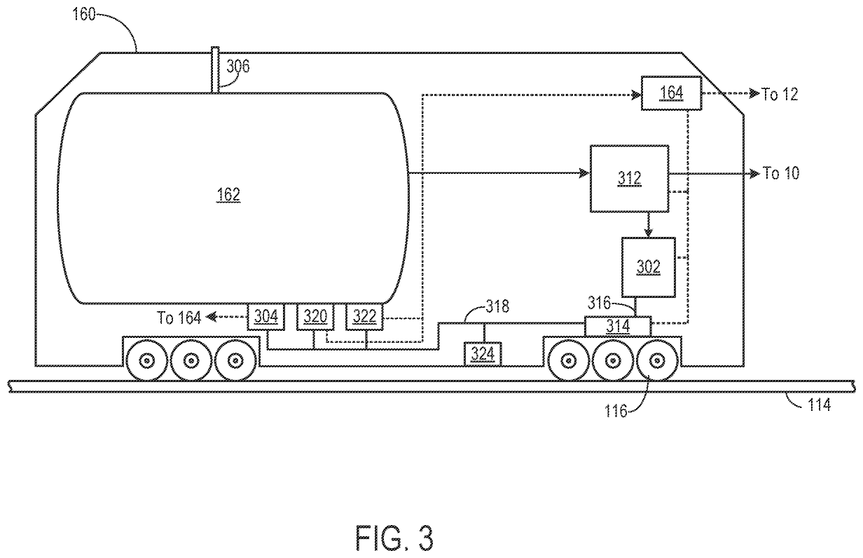

In one example, the fuel tender may be non-powered for propulsion, e.g., without an engine or electric traction motors (e.g., electric traction motors 124 shown in FIG. 2). However, in other examples, the fuel tender may be powered for propulsion. For example, as shown in FIG. 3, the fuel tender may include an engine (e.g., engine 302), which may be similarly configured to the engines of the locomotives, or may have a different configuration. The engine of the fuel tender may combust the fuel stored in the fuel storage tank and/or fuel stored at another vehicle of the train.

The one or more fuel storage tanks of the fuel tender may have a suitable structure for storing a specific type of fuel. In one example, the fuel storage tank may be adapted for cryogenic storage of liquefied natural gas (LNG). As another example, the fuel storage tank may store a fuel in a liquid state at ambient temperature and pressure, such as diesel or ammonia. In yet another example, the fuel storage tank may be configured to store a fuel as a compressed gas, such as hydrogen. In each instance, the fuel tender may be equipped with various mechanisms and devices for storage of the particular fuel. Further details of the fuel tender are shown further below, with reference to FIG. 3.

In some examples, fuel may be stored only at the fuel tender. In other examples, however, fuel may be stored both at the fuel tender and at one or more of the locomotives, e.g., as shown in FIG. 2. In addition, in some instances the fuel tender may also be configured to store a fuel cell system, including a fuel cell and one or more tanks of compressed hydrogen gas. Alternatively, the fuel cell system may be stored at one or more of the locomotives.

FIG. 2 depicts an example embodiment of a rail vehicle of the train from FIG. 1, herein depicted as the locomotive 102, configured to run on the track via a plurality of wheels 116. Power for propulsion of the locomotive may be supplied at least in part by the engine. The engine receives intake air for combustion from an intake passage 118. The intake passage receives filtered ambient air from an air filter (not shown). Exhaust gas resulting from combustion in the engine is supplied to an exhaust passage 120. Exhaust gas flows through the exhaust passage, and out of an exhaust stack (not shown) of the locomotive.

In one embodiment, the engine operates as a compression ignition engine configured to combust at least one type of fuel. In another embodiment, the engine operates as a spark ignition engine similarly configured to combust at least one type of fuel. For example, the engine may combust one specific fuel type only or may be able to combust two or more types of fuel, e.g., a multi-fuel engine. As such, the different fuel types may be combusted individually or co-combusted, e.g., combusted concurrently, at the engine. In one embodiment, the multi-fuel engine may be a dual fuel engine, as depicted in FIG. 2, the dual fuel engine configured to receive a first fuel from a first fuel reservoir 134 and a second fuel from a second fuel reservoir 136.

While the locomotive is equipped with two fuel reservoirs in FIG. 2, in other examples, the locomotive may include only one fuel reservoir or no fuel reservoir. For example, at least one of the fuel reservoirs may be stored at the fuel tender, e.g., the fuel tender of FIG. 1. Alternatively, a third fuel may be stored at the fuel tender in addition to the first fuel at the first fuel reservoir and the second fuel at the second fuel reservoir of the locomotive. In one example, fuels which may be stored at ambient pressure and temperature without any additional equipment or specialized storage tank configurations, such as diesel, may be stored at the locomotive. Fuels demanding specialized equipment, such as for cryogenic or high pressure storage, may be stored on-board the fuel tender. In other examples, however, the locomotive and the fuel tender may each store fuels that do not demand specialized equipment.

The first, second, and third fuels (e.g., any fuels stored on-board the train) may each be any of a number of different fuel types. For example, the types of fuel may include carbon-based fuels, such as diesel, natural gas, methanol, ethanol, other alcohols, dimethyl ether (DME), other ethers, biodiesel, HDRD, syn-gas, etc. Alternatively, the fuels may be non-hydrocarbon-based fuels, such as hydrogen, ammonia, water, etc. The fuels listed above are non-limiting examples of fuels which may be combusted at the engine and various other types of fuels are possible.

Additionally, each of the stored fuels may be a gaseous or a liquid phase fuel. Thus, when configured as a compression ignition engine combusting a single fuel type, the engine may consume a gaseous fuel or a liquid fuel. When the compression ignition engine is a multi-fuel engine, the engine may combust only liquid fuels, only gaseous fuels, or a combination of liquid and gaseous fuels. Similarly, when configured as a spark ignition engine combusting a single fuel type, the engine may also consume either a gaseous fuel or a liquid fuel. When configured as a multi-fuel spark ignition engine, the engine may combust only liquid fuels, only gaseous fuels, or a combination of liquid and gaseous fuels.

As either of the spark ignition or the compression ignition multi-fuel engine configurations, the engine may combust fuel combinations in different manners. For example, one fuel type may be a primary combustion fuel and another fuel type may be a secondary, additive fuel used under certain conditions to adjust combustion characteristics. For example, during engine startup, a fuel combustion mixture may include a smaller proportion of diesel to seed ignition while hydrogen may form a larger proportion of the mixture. In other examples, one fuel may be used for pilot injection prior to injection of the primary combustion fuel. In some examples, the substitution rate may be set based on one or more conditions to increase an amount of carbon-free fuel to decrease carbon emissions. A substitution rate of carbon-free fuels used may be adjusted based on a desired ignition timing, wherein the desired ignition timing is based on one or more of an engine load, an intake manifold temperature and pressure, and a ignitibility of the fuel mixture.

The engine, as the multi-fuel engine, may be configured to combust various combinations of the fuels and the fuels may be premixed or not premixed prior to combustion. In one example, the first fuel may be hydrogen and the second fuel may be diesel. In another example, the first fuel may be ammonia and the second fuel may be diesel. In yet another example, the first fuel may be ammonia and the second fuel may be ethanol. Further combinations are possible with storage of the third fuel on the fuel tender. For example, LNG may be stored at the fuel tender and the engine may be configured to combust LNG and hydrogen, or LNG, diesel, and hydrogen, or LNG, ammonia, and hydrogen. As such, numerous combinations of fuel types are possible, where the combinations may be determined based on compatibility of the fuels. A method of delivery of the fuels to the engine for combustion may similarly depend on properties of the fuel type.

When engine conditions permit combustion of only a single fuel (either spark ignition or compression ignition), the engine may consume a single liquid phase fuel. For example, the engine may combust diesel, gasoline, ammonia, LNG, or another liquid phase fuel. Similarly, the engine may be configured to combust a single gaseous fuel, such as hydrogen, or another gaseous fuel.

Furthermore, a fuel that is stored on-board in one physical state, e.g., gas or liquid, may be delivered to the engine in the same state or a different state. For example, LNG may be stored cryogenically in the liquid phase but may undergo a transition to the gas phase, e.g., at a regasification unit in the fuel tender, prior to injection at the engine. Other fuels, however, may be stored as a liquid and injected as a liquid or stored as a gas and injected as a gas.

Each type of injection may include injection of either gaseous or liquid phase fuels. However, some injection methods may be more suitable for certain fuels depending on specific properties of the fuel type. For example, hydrogen may be injected by port injection or direct injection. Liquid phase fuels, such as diesel, may be injected by direct injection. Ammonia and natural gas may each be injected by port injection or direct injection. Similarly, fuels such as methanol and ethanol may also be either port injected or direct injected. In some instances, the engine may be configured with fuel injectors capable of switching between injection of gaseous fuels and of liquid fuels.

The fuels combusted by the multi-fuel engine, whether in the gas phase or liquid phase, may or may not be premixed prior to combustion according to the type of fuel. For example, depending on operating conditions, premixing of hydrogen, natural gas, ammonia, methanol, ethanol, and DME may be desirable. During other operating conditions, fuels such as diesel, hydrogen, natural gas, methanol, and ethanol may not be premixed. For example, a greater magnitude of premixing hydrogen may be desired at higher loads and a lower magnitude of premixing hydrogen may be desired at lower loads. Premixing of the fuels may include port injection of at least one of the fuels into an inlet manifold or inlet port where the fuel may mix with air before entering a cylinder. As another example, each of the fuels may be port injected, allowing the fuels to mix with one another and with air prior to combustion. In other examples, the fuel(s) may be injected into a pre-combustion chamber fluidly coupled to a cylinder head where the fuel(s) may mix with air in the pre-combustion chamber before flowing to the cylinder head.

Alternatively, the fuels may be delivered to the engine cylinders by directly injecting one or more fuels into the engine cylinders when the cylinders are filled with at least the compressed air and, in some instances, the gas phase fuel. Direct injection may include high pressure direct injection (HPDI) and low pressure direct injection (LPDI). When direct injected, the fuels may not be premixed, in one example. However, in another example, premixing may be enabled by direct injection of one or more of the fuels prior to a compression stroke of the engine cylinders, as described above.

Furthermore, a type of gaseous fuel used may determine whether direct injection of the fuel may include HPDI or LPDI, or both HPDI and LPDI. For example, hydrogen, when stored as a compressed gas, may be injected by HPDI or by LPDI, depending on engine load and available delivery pressure. In particular, HPDI of hydrogen may alleviate knock due to continuous burning of the hydrogen as the hydrogen mixes in the engine cylinders. Furthermore, HPDI may enable greater substitution rates of hydrogen, e.g., substituting for diesel, for example, thereby decreasing hydrocarbon, NOₓ, and particulate matter emissions during engine operation.

As shown in FIG. 2, the engine is coupled to an electric power generation system, which includes an alternator/generator 122 and the electric traction motors. For example, the engine generates a torque output that is transmitted to the alternator/generator which is mechanically coupled to the engine. The alternator/generator produces electrical power that may be stored and applied for subsequent propagation to a variety of downstream electrical components. As an example, the alternator/generator may be electrically coupled to the electric traction motors and the alternator/generator may provide electrical power to the electric traction motors. As depicted, the electric traction motors are each connected to one of a plurality of wheels to provide tractive power to propel the locomotive. One example locomotive configuration includes one traction motor per wheel. As depicted, six pairs of traction motors correspond to each of six pairs of wheels of the locomotive.

The locomotive may further include a turbocharger 126 arranged between the intake passage and the exhaust passage. The turbocharger increases air charge of ambient air drawn into the intake passage in order to provide greater charge density during combustion to increase power output and/or engine-operating efficiency. The turbocharger may include a compressor (not shown) which is at least partially driven by a turbine (not shown). While in this case a single turbocharger is included, the system may include multiple turbine and/or compressor stages. Further, in some embodiments, a wastegate may be provided which allows exhaust gas to bypass the turbocharger. The wastegate may be opened, for example, to divert the exhaust gas flow away from the turbine. In this manner, the rotating speed of the compressor, and thus the boost provided by the turbocharger to the engine, may be regulated.

The locomotive further may include an exhaust gas recirculation (EGR) system 170, which routes exhaust gas from the exhaust passage upstream of the turbocharger to the intake passage downstream of the turbocharger. The EGR system includes an EGR passage 172 and an EGR valve 174 for controlling an amount of exhaust gas that is recirculated from the exhaust passage of the engine to the intake passage of the engine. By introducing exhaust gas to the engine, the amount of available oxygen for combustion is decreased, thereby reducing the combustion flame temperatures and reducing the formation of nitrogen oxides (e.g., NOₓ). The EGR valve may be an on/off valve controlled by the locomotive controller, or it may control a variable amount of EGR, for example.

The EGR system may further include an EGR cooler 176 to reduce the temperature of the exhaust gas before it enters the intake passage. As depicted in the non-limiting example embodiment of FIG. 2, the EGR system is a high-pressure EGR system. In other embodiments, the locomotive may additionally or alternatively include a low-pressure EGR system, routing EGR from a location downstream of the turbocharger to a location upstream of the turbocharger relative to a direction of exhaust gas flow. Additionally, the EGR system may be a donor cylinder EGR system where one or more cylinders provide exhaust gas only to the EGR passage, and then to the intake. Additionally or alternatively, the donor cylinder EGR system may include routing exhaust gases directly to one or more adjacent cylinders.

The locomotive includes an exhaust gas treatment system coupled in the exhaust passage to reduce regulated emissions. In one example embodiment, the exhaust gas treatment system may include a diesel oxidation catalyst (DOC) 130 and a diesel particulate filter (DPF) 132. The DOC may oxidize exhaust gas components, thereby decreasing carbon monoxide, hydrocarbons, and particulate matter emissions. The DPF is configured to trap particulates, also known as particulate matter (an example of which is soot), produced during combustion, and may be comprised of ceramic, silicon carbide, or any suitable material. In other embodiments, the exhaust gas treatment system may additionally include a selective catalytic reduction (SCR) catalyst, three-way catalyst, NO trap, various other emission control devices or combinations thereof. In some embodiments, the exhaust gas treatment system may be positioned upstream of the turbocharger, while in other embodiments, the exhaust gas treatment system may be positioned downstream of the turbocharger.

The locomotive may further include a throttle 142 coupled to the engine to indicate power levels. In this embodiment, the throttle is depicted as a notch throttle. However, any suitable throttle is within the scope of this disclosure. Each notch of the notch throttle may correspond to a discrete power level. The power level indicates an amount of load, or engine output, placed on the locomotive and controls the speed at which the locomotive will travel. Although eight notch settings are depicted in the example embodiment of FIG. 2, in other embodiments, the throttle notch may have more than eight notches or less than eight notches, as well as notches for idle and dynamic brake modes. In some embodiments, the notch setting may be selected by a human operator of the locomotive. In one example, a value of the notch setting corresponds to an engine load, wherein a higher value is equal to a higher engine load. In other embodiments, the consist controller may determine a trip plan (e.g., a trip plan may be generated using trip optimization software, such as Trip Optimizer™ system available from Wabtec Corporation and/or a load distribution plan may be generated using consist optimization software such as Consist Manager™ available from Wabtec Corporation) including notch settings based on engine and/or locomotive operating conditions, as will be explained in more detail below.

The engine controller may control various components related to the locomotive. As an example, various components of the locomotive may be coupled to the engine controller via a communication channel or data bus. In one example, the engine controller and the consist controller each include a computer control system. The engine controller and consist controller may additionally or alternatively include a memory holding non-transitory computer readable storage media (not shown) including code for enabling on-board monitoring and control of locomotive operation. The engine controller may be coupled to the consist controller, for example, via a digital communication channel or data bus.

Both the engine controller and the consist controller may receive information from a plurality of sensors and may send control signals to a plurality of actuators. The engine controller, while overseeing control and management of the locomotive, may be configured to receive signals from a variety of engine sensors 150, as further elaborated herein, in order to determine operating parameters and operating conditions, and correspondingly adjust various engine actuators 152 to control operation of the locomotive. For example, the engine controller may receive signals from various engine sensors including, but not limited to, engine speed, engine load, intake manifold air pressure, boost pressure, exhaust pressure, ambient pressure, ambient temperature, exhaust temperature, engine temperature, exhaust oxygen levels, etc. Correspondingly, the engine controller may control the locomotive by sending commands to various components such as the electric traction motors, the alternator/generator, cylinder valves, fuel injectors, the notch throttle, etc. Other actuators may be coupled to various locations in the locomotive.

The consist controller may include a communication portion operably coupled to a control signal portion. The communication portion may be configured to receive signals from locomotive sensors including locomotive position sensors (e.g., GPS device), environmental condition sensors (e.g., for sensing altitude, ambient humidity, temperature, and/or barometric pressure, or the like), locomotive coupler force sensors, track grade sensors, locomotive notch sensors, brake position sensors, etc. Various other sensors may be coupled to various locations in the locomotive. The control signal portion may generate control signals to trigger various locomotive actuators. Example locomotive actuators may include air brakes, brake air compressor, traction motors, etc. Other actuators may be coupled to various locations in the locomotive. The consist controller may receive inputs from the various locomotive sensors, process the data, and trigger the locomotive actuators in response to the processed input data based on instruction or code programmed therein corresponding to one or more routines. Further, the consist controller may receive engine data (as determined by the various engine sensors, such as an engine coolant temperature sensor) from the engine controller, process the engine data, determine engine actuator settings, and transfer (e.g., download) instructions or code for triggering the engine actuators based on routines performed by the consist controller back to the engine controller.

For example, the consist controller may determine a trip plan to distribute load amongst all locomotives in the train, based on operating conditions. In some conditions, the consist controller may distribute the load unequally, that is, some locomotives may be operated at a higher power setting, or higher notch throttle setting, than other locomotives. The load distribution may be based on a plurality of factors, such as fuel economy, coupling forces, tunneling operating, grade, etc. In one example, the load distribution may be adapted based on a distribution of the locomotive consist, e.g., a positioning of each of the locomotives of the locomotive consist, across the train. For example, at least one locomotive may be positioned at an end of the train and at least one locomotive may be positioned at a front of the train. The locomotive at the end of the train may be configured to push propulsion of the train and the locomotive at the front of the train may be configured to pull the train, particularly during uphill navigation. As such, a greater load may be placed on the pushing locomotive at the end of the train.

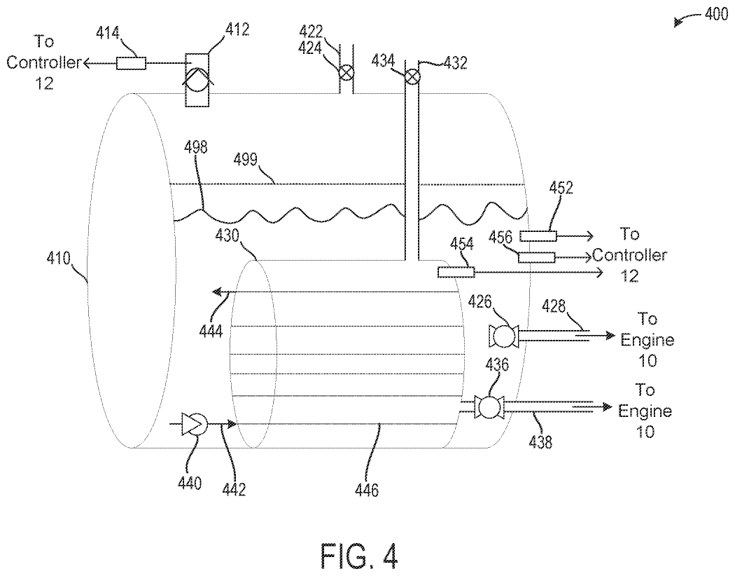

Turning now to FIG. 3, an embodiment of the fuel tender of FIG. 1 is shown. As described above, the fuel tender includes the fuel storage tank, the controller, and the engine. The fuel tender may further include a first unit 304, which may be a device for controlling a temperature and pressure within the fuel storage tank. For example, when LNG is stored in the fuel storage tank, the first unit may be a cryogenic unit. The fuel storage tank may have various sizes and configurations, may be removable from the fuel tender, and may be configured to receive fuel from an external refueling station via port 306. In some examples, additionally or alternatively, the fuel storage tank may store a plurality of fuels separately from one another therein. An embodiment of such a fuel storage tank is shown in the example of FIG. 4.

The fuel storage tank may supply fuel to a fuel modification unit 312. The fuel modification unit may be configured to adjust a characteristic of the fuel. For example, the fuel may be converted from a liquid phase to a gas phase at the fuel modification unit, such as when the fuel is LNG. As another example, the fuel modification unit may be a pump to adjust a delivery pressure of the fuel when the fuel is stored in the gas phase. In other examples, where fuel modification is not demanded, the fuel modification unit may be omitted. The fuel may be delivered from the fuel modification unit to engines of the locomotives (e.g., the engines 10 of FIGS. 1 and 2).

By supplying fuel from the fuel storage tank to the locomotive engines and the engine of the fuel tender, the fuel may be combusted by the engines distributed across the train. In another non-limiting embodiment, the fuel tender engine may be further configured to generate electricity that may be delivered to one or more components on-board the fuel tender and/or on-board the locomotives. In one example, as depicted in FIG. 3, the fuel tender engine may generate torque that is transmitted to a power conversion unit 314 via drive shaft 316. The power conversion unit is configured to convert the torque into electrical energy that is delivered via electrical bus 318 to a variety of downstream electrical components in the fuel tender. Such components may include, but are not limited to, the first unit, the fuel modification unit, the controller, a pressure sensor 320, a temperature sensor 322, batteries 324, various valves, flow meters, additional temperature and pressure sensors, compressors, blowers, radiators, batteries, lights, on-board monitoring systems, displays, climate controls, and the like, some of which are not illustrated in FIG. 3 for brevity. Additionally, electrical energy from the electrical bus may be provided to one or more components of the locomotives.

In one example the power conversion unit includes an alternator (not shown) that is connected in series to one or more rectifiers (not shown) that convert the alternator's AC electrical output to DC electrical power prior to transmission along the electrical bus. Based on the configuration of a downstream electrical component receiving power from the electrical bus, one or more inverters may be configured to invert the electrical power from the electrical bus prior to supplying electrical power to the downstream component. In one example, a single inverter may supply AC electrical power from a DC electrical bus to a plurality of components. In another non-limiting embodiment, each of a plurality of distinct inverters may supply electrical power to a distinct component.

The controller on-board the fuel tender may control various components on-board the fuel tender, such as the fuel modification unit, the fuel tender engine, the power conversion unit, the first unit, control valves, and/or other components on-board the fuel tender, by sending commands to such components. The controller may also monitor fuel tender operating parameters in active operation, idle and shutdown states. Such parameters may include, but are not limited to, the pressure and temperature of the fuel storage tank, a pressure and temperature of the fuel modification unit, the fuel tender engine temperature, pressure, and load, compressor pressure, heating fluid temperature and pressure, ambient air temperature, and the like. In one example, computer readable storage media configured in the fuel tender controller may execute code to auto-stop, auto-start, operate and/or tune the engine and the fuel modification unit in response to one or more control system routines. The computer readable storage media may also execute code to transmit to and receive communications from the engine controllers on-board the locomotives.

The fuel tender depicted in FIG. 3 is a non-limiting example of how the fuel tender may be configured. In other examples, the fuel tender may include additional or alternative components. As an example, the fuel tender may further include one or more additional sensors, flow meters, control valves, various other device and mechanisms for controlling fuel delivery and storage conditions, etc.

Turning now to FIG. 4, it shows an embodiment of a multi-fuel fuel system 400. The fuel system may include a first tank 410 and a second tank 430. The first tank may comprise a first fuel. The second tank may comprise a second fuel, different than the first fuel in one or more of physical state, carbon content, and fuel type. The fuels housed in the fuel tanks may include a carbon-free fuel and a carbon-containing fuel, in one embodiment. The carbon-free fuel may include one or more of ammonia and hydrogen. The carbon-containing fuel may include one or more of diesel, hydrogenation-derived renewable diesel (HDRD), biodiesel, syn-gas, alcohol, gasoline, kerosene, ether, and natural gas. Additionally or alternatively, the fuel tanks may house fuels with different amounts of carbon. In the embodiment of FIG. 4, the first tank may house a liquid fuel and the second tank may house a gaseous fuel or cryogenic liquid, such as liquefied natural gas. In one example, the first tank comprises diesel and the second tank comprises hydrogen.

A size and a volume of the first tank may be greater than a size and a volume of the second tank. The second tank may be located within an interior volume of the first tank. In the example of FIG. 4, the second tank is physically coupled to a bottom surface of the first tank. In some embodiments, additionally or alternatively, the second tank may be physically coupled to side walls or a top wall of the first tank. In other embodiments, additionally or alternatively, mounting elements may suspend the second tank within the first tank so that walls of the second tank are spaced away from walls of the first tank.

The first tank may be shaped to match an available packaging space of the mobile asset. The first tank may include non-smooth features, such as bends, turns, protrusions, indentations, and other accommodating features to match the available packaging space. Additionally or alternatively, the first tank may include a cylindrical, spherical, cubical, rectangular prism, or other shape.

The second tank may include a cylindrical, spherical, cubical, rectangular prism, or other shape free of protrusions, indentations, or other deviations. The size and the shape of the second tank may be further configured to be submerged in the first fuel of the first tank. An outer jacket or shell (e.g., an exterior surface) of the second tank may be wrapped or coated with a material configured to mitigate degradation due to contact with the first fuel in the first tank. For example, the outer jacket of the second tank may include a rubber, a plastic, an epoxy resin, or other material resistant to degradation in the presence of the liquid fuel. In one example, a coating of the outer jacket of the second tank may be identical to a coating of the inner surface of the first tank.

A relief valve 412 may be arranged in the top wall of the first tank and coupled to a headspace thereof. The relief valve may open in response to a pressure of the interior volume of the first tank and/or in response to engine conditions or canister conditions. For example, the relief valve may open and release fuel vapors to a canister configured to store vapors until combustion conditions may combust the stored fuel vapors.

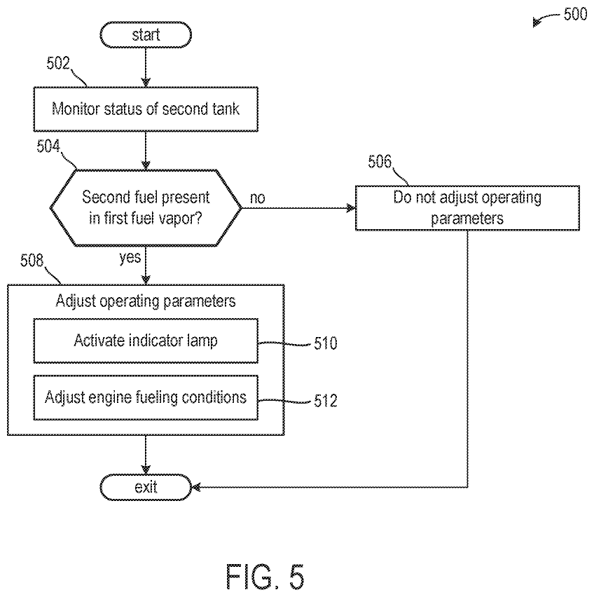

A second fuel sensor 414 may be coupled to the relief valve or to a fuel passage downstream of the relief valve. The second fuel sensor may be configured to sense a presence of the second fuel mixed with vapors of the liquid fuel. For example, if the liquid fuel is diesel and the second fuel stored in the second tank is hydrogen, the second fuel sensor may distinguish the hydrogen from the diesel vapors and provide feedback to a controller (e.g., controller 12 of FIG. 2) indicating a level of the second fuel mixed with the vapors of the first fuel. The controller may compare the level to a threshold level to determine if degradation of the second tank or other component thereof is present. A method for adjusting operating parameters based on a presence of gaseous fuel being present in the vapors of the liquid fuel tank is described below with respect to FIG. 5.

The first tank may include a first tank inlet 422. The first tank inlet may be coupled to a refill nozzle through which the first fuel may be dispensed via a fuel nozzle of a fuel station or an exterior fuel tank. A refill valve 424 may be positioned in the first tank inlet. The refill valve may admit fuel into the first tank via the first tank inlet while blocking fuel vapors from escaping the first tank via the first tank inlet. In one example, the first tank inlet may dispense fuel into only the first tank and does not provide fuel to the second tank.

The first tank may further include a first fuel pump 426 fluidly coupled to a first tank outlet 428. The first fuel pump may draw the first fuel from the first tank and force it into the first tank outlet toward a first fuel fuel rail of an engine (e.g., engine 10 of FIG. 2).

The second tank may include a second tank inlet 432. The second tank inlet may be coupled to a refill nozzle through which the second fuel may be dispensed via a fuel nozzle of a fuel station or an exterior fuel tank. A refill valve 434 may be positioned in the second tank inlet. The refill valve may admit the second fuel into the second tank via the second tank inlet while blocking vapors of the second fuel from escaping the second tank via the second tank inlet. In one example, the second tank inlet may dispense the second fuel into only the second tank and the second fuel does not mix with the first fuel in the interior volume of the first tank.

The second tank may further include a second fuel pump 436 fluidly coupled to a second tank outlet 438. The second fuel pump may draw the second fuel from the second tank and force it into the second tank outlet toward a second fuel fuel rail of an engine (e.g., engine 10 of FIG. 2). The second fuel fuel rail may be fluidly separated from the first fuel fuel rail. In some examples, additionally or alternatively, the second fuel may be pressurized within the second tank and the second fuel pump may be replaced with a valve.

The second tank may be positioned below a first fuel fill limit line 499 of the first tank. The first fuel fill limit line may be etched or marked within the first tank, which may facilitate more efficient manufacture of the fuel system. The second tank may be cooled via contact with the first fuel in the first tank. In one example, the first fuel may passively cool the second tank. In some examples, the second tank may be completely submerged by the first fuel. Additionally or alternatively, the second tank may only be partially submerged by the first fuel.

In some embodiments, additionally or alternatively, the second tank may be spaced away from the first fuel and in the interior volume of the first tank. The first fuel may not contact the second tank. The fuel system may include an active cooling system configured to cool the second tank and/or components thereof, such as the inlet and the outlet via the first fuel. The active cooling system may include a cooling pump 440 coupled to a coolant inlet 442. A coolant passage 446 may wrap around an exterior of the second tank. The coolant passage may be coupled to the coolant inlet and to a coolant outlet 444. The coolant outlet may expel coolant from the coolant passage to the interior volume of the first tank. The second tank may be positioned above the first fuel fill limit line such that only a portion of the second tank is submerged in the first coolant if an active cooling system is included in the fuel system.

Control of the cooling pump may be based on feedback from a first tank temperature sensor 452 and/or a second tank temperature sensor 454. In one example, the second tank temperature sensor may be omitted and a temperature of the second tank may be estimated based on the first fuel temperature sensed by the first tank temperature sensor. If the temperature of the second tank is greater than a threshold second tank temperature, then active cooling may be initiated. For example, the cooling pump or the agitator may be activated to allow increased heat transfer from the second tank to the first fuel.

In some embodiments, additionally or alternatively, the active cooling system may include an agitator, a mixer, or a pump configured to introduce turbulence to the first fuel when cooling of the second tank is desired.

Refueling of the second tank may be adjusted based on one or more of a temperature of the first fuel and a first fuel level 498. The first fuel level may be determined via a fuel level sensor 456. For example, as the first fuel level decreases or as the temperature of the first fuel increases, a refueling limit of the second tank may decrease. Additionally or alternatively, as the first fuel level increases or as the temperature of the first fuel decreases, the refueling limit of the second tank may increase. The refueling limit may be further adjusted in response to an amount of fuel requested during the refueling of the second tank and an ambient temperature. The amount of fuel requested during the refueling may be based on a difference between a current second fuel level and a second fuel fill limit. As the difference increases, a temperature rise during the refueling may also increase. If the first fuel is unable to maintain a temperature of the second tank within a desired range due to the first fuel temperature and/or the first fuel level, then the refueling limit may be adjusted to a value less than the difference.

Turning now to FIG. 5, a high-level flowchart shows a method 500 for determining a condition of the second fuel tank. The method may be executed by a controller of a vehicle, such as the controller of FIGS. 1-4, based on instructions stored in a memory of the controller.

The method may begin at step 502, where the method may include monitoring a status of the second tank. Monitoring the second tank may include receiving feedback from the second fuel sensor with regard to a concentration of the second fuel in the first fuel.

At step 504, the method may include determining if the second fuel is present in the first fuel vapors. When the first fuel vapors are vented out of the first tank, the second fuel sensor monitors the vapors for the presence of the second fuel. If the second fuel is not present in the first fuel vapors, then a degradation of the second fuel tank and/or conduits thereof, such as the second fuel inlet and the second fuel outlet, may not be present.

At step 506, following determining the second fuel is not present in the first fuel vapor, the method includes not adjusting operating parameters of the fuel system and/or the engine system. As such, a substitution rate of the engine or a refilling operation of the fuel system is not adjusted based on degradation of the second tank.

If the second fuel is present in the first fuel vapor, then at step 508, the method may include adjusting fuel system and/or engine system operating parameters based on a degradation of the second tank and/or a component thereof.

At step 510, the method may include activating an indicator lamp. Activating the indicator lamp may further include notifying a vehicle operator via an electronic message (e.g., text, email, message on a vehicle infotainment screen, etc.), a phone call, or a sound that the second fuel tank is degraded. The notification may further include information regarding service centers available for servicing the fuel system.

At step 512, the method may include adjusting engine fueling conditions. For example, adjusting engine fueling conditions may include adjusting a demanded substitution rate of the first fuel and the second fuel. For example, the substitution rate may be decreased to account for the presence of the second fuel in the first fuel. A magnitude of the reduction of the demanded substitution rate may be proportional to the concentration of the second fuel in the first fuel. As the demanded substitution rate decreases, the amount of second fuel demanded decreases. However, due to the presence of the second fuel in the first fuel, the first fuel delivered to the engine may include an amount of the second fuel, resulting in an actual substitution rate being higher than the demanded substitution rate.

Additionally or alternatively, adjusting operating parameters may include limiting an engine power output. Additionally or alternatively, fuel from a fuel tank other than the first tank and the second tank may be delivered to the engine. In some embodiments, the engine may be deactivated and fuel may not be delivered thereto. The vehicle may be electrically powered or via another energy source other than fuels in the first tank and the second tank.

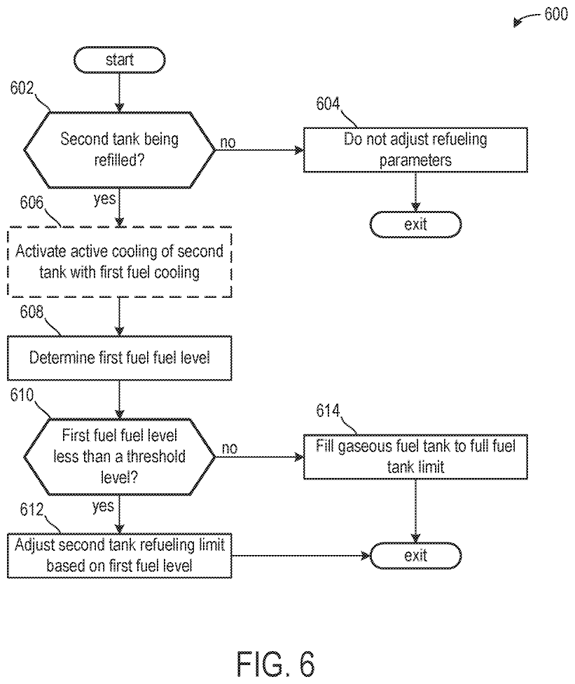

Turning now to FIG. 6, it shows a method 600 for adjusting refueling parameters of the second tank based on a fuel level of the first fuel in the first tank.

At step 602, the method includes determining if the second tank is being refilled. The second tank may be being refilled if a fuel nozzle is inserted into second fuel inlet and dispensing fuel.

If the second tank is not being refilled, then at step 604, the method may include not adjusting refueling parameters.

If the second tank is being refilled, then, optionally, at step 606, the method may include activating active cooling of the second tank with first fuel cooling. In one example, active cooling is desired in response to a temperature of the second tank during the refueling event and/or in response to a temperature of the first fuel. For example, if the temperature of the second tank is greater than a threshold refilling temperature based on an upper value of the desired temperature range of the second tank, then active cooling may be desired.

At step 608, the method may include determining a first fuel level. The first fuel level may be determined via the fuel level sensor or tracked over time based on a refilling the first tank and consumption of the first fuel.

At step 610, the method may include determining if the first fuel level is less than a threshold level. In one example, the threshold level is equal to the first fuel tank fill limit, shown in FIG. 4. Additionally or alternatively, the threshold level may be equal to a level of first fuel in the first tank submerging the second tank. Even with active cooling present, if the first fuel level is below the threshold level, cooling the second tank with the first fuel may result in the first fuel exceeding a threshold first fuel temperature or the second tank exceeding the threshold refilling temperature. The threshold level may be a dynamic value adjusted based on one or more of the temperature of the first fuel, a temperature of the second tank, and an amount of fuel requested during the refueling of the second tank. For example, the threshold level may increase as the amount of fuel requested during the refueling of the second tank increases to account for a greater temperature increase of the second tank. Additionally or alternatively, the threshold level may increase as the temperature of the first fuel increases.

If the first fuel level is less than the threshold level, then at step 612, the method may include adjusting the second tank refueling limit based on the first fuel level. For example, the second tank refueling limit may be less than a second tank fill limit in response to the first fuel level being less than the threshold level. A magnitude of a reduction of the second tank refueling limit may be based on a difference between the first fuel level and the threshold level. As the difference increases, the second tank refueling limit may be further reduced.

In some examples, additionally or alternatively, a refueling rate of the second tank may be adjusted. For example, the second tank may be filled over a longer period of time when the first fuel level is less than the threshold level. Additionally or alternatively, a first amount of second fuel may be dispensed to the second tank. Following a duration of time based on a temperature reduction of the first fuel and the second tank, a second amount of second fuel may be dispensed. The second fuel may be dispensed to the second tank fractionally based on maintaining the temperature of the second tank below the threshold refilling temperature.

Additionally or alternatively, if the second tank refilling is anticipated to be adjusted, then the method may optionally include prompting the user to refill the first tank with first fuel prior to refilling the second tank with second fuel. By doing this, a likelihood of the first fuel level being equal to or greater than the threshold level may increase and refilling of the second tank may not be adjusted.

If the first fuel level is equal to or greater than the threshold level, then at step 614, the method may include filling the second fuel tank to the second tank full fuel limit. The first fuel may cool the second tank as the second tank temperature increases due to second fuel being dispensed therein.

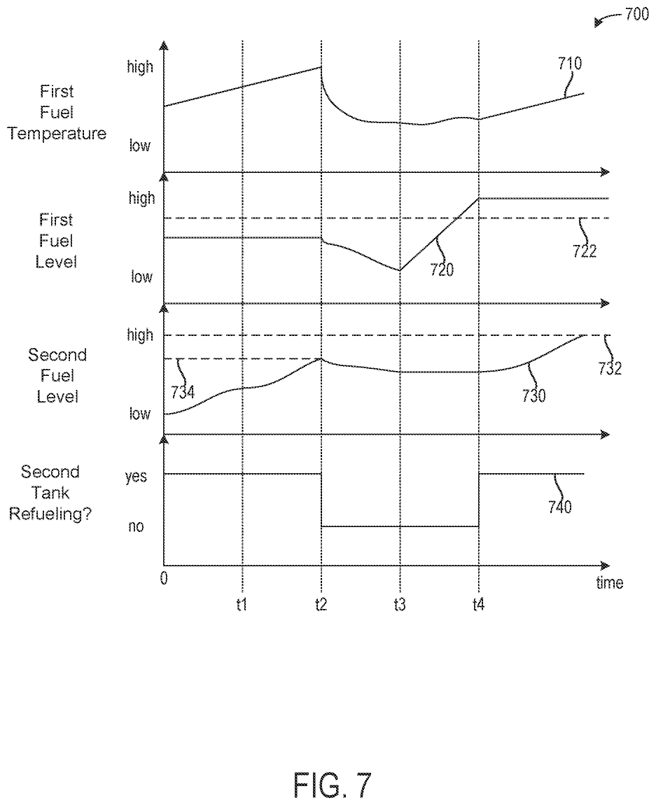

Turning now to FIG. 7, it shows a plot 700 graphically illustrating conditions during operation of the mobile asset. The conditions may include operations during and outside of a refueling of the first tank and the second tank. Plot 710 illustrates a first fuel temperature. Plot 720 illustrates a first fuel level. Dashed line 722 illustrates a threshold first fuel level. Plot 730 illustrates a second fuel level. Dashed line 732 illustrates a second tank fill limit and dashed line 734 illustrates an adjusted second tank fill limit. Plot 740 illustrates if the second tank is refueling. Time increases from a left to right side of the figure.

Prior to t1, the second tank refueling is occurring (plot 740). As such, the second fuel level increases. The first fuel level (plot 720) is less than the threshold first fuel level (dashed line 722). As such, the second tank refueling is adjusted to fill to only the adjusted second tank fill limit (dashed line 734), which is less than the second tank fill limit (dashed line 732). Additionally or alternatively, in some examples, the second tank refueling may be adjusted to include where a refueling rate is adjusted (e.g., decreased) or a period of time in which the refueling occurs is adjusted (e.g., increased) in response to the first fuel level being less than the threshold first fuel level. The first fuel temperature increases during the refueling (plot 710).

At t1 and between t1 and t2, the second tank refueling continues. At t2, the second fuel level is equal to the adjusted second tank fill limit and the second tank refueling is complete.

Between t2 and t3, the mobile asset is active and the first fuel level and the second fuel level decrease as the first fuel and the second fuel are consumed by an engine. At t3, the first fuel level increases in response to the first tank being refilled.

Between t3 and t4, the first fuel level increases above the threshold first fuel level to a fill limit of the first tank. At t4, the first tank refueling is complete and second tank refueling is initiated. After t4, the second tank is refilled to the second tank fill limit. The second tank fill limit is not adjusted due to the first fuel level being greater than the threshold first fuel level.

The technical effect of the multi-fuel fuel system is to provide a compact fuel arrangement while decreasing emissions of a mobile asset. The compact fuel arrangement may include a secondary fuel fuel tank arranged in an interior volume of a liquid fuel tank. The liquid fuel may be further configured to quench the secondary fuel in response to a degradation of the second tank.

The disclosure provides support for a system including a first fuel arranged in an interior volume of a first tank and a second fuel arranged in an interior volume of a second tank, the second tank arranged in the interior volume of the first tank and in contact with the first fuel. A first example of the system further includes where the second tank is hermetically sealed from the interior volume of the first tank. A second example of the system, optionally including the first example, further includes where the second tank is submerged in the first fuel. A third example of the system, optionally including one or more of the previous examples, further includes where the first fuel is a liquid fuel and the second fuel is a gaseous fuel. A fourth example of the system, optionally including one or more of the previous examples, further includes a cooling system configured to cool the second tank via the first fuel. A fifth example of the system, optionally including one or more of the previous examples, further includes where wherein the second fuel is a cryogenic liquid or a solid fuel. A sixth example of the system, optionally including one or more of the previous examples, further includes where the first fuel is different than the second fuel, and wherein the first fuel and the second fuel comprise two of diesel, hydrogenation-derived renewable diesel (HDRD), biodiesel, syn-gas, alcohol, gasoline, kerosene, ether, natural gas, ammonia, and hydrogen.

The disclosure further provides support for a fuel system including a first fuel arranged in an interior volume of a first tank, a second fuel arranged in an interior volume of a second tank, the second tank arranged in the interior volume of the first tank and in contact with the first fuel, a vent valve coupled to the interior volume of the first tank, wherein a second fuel sensor is coupled to the vent valve and configured to sense a concentration of the second fuel in vapors of the first fuel, and a controller with instructions stored on memory thereof that when executed cause the controller to determine a condition of the second tank the concentration of the second fuel in vapors of the first fuel. A first example of the fuel system further includes where the condition is the second tank is degraded in response to the concentration being greater than a threshold concentration. A second example of the fuel system, optionally including the first example, further includes where the instructions further cause the controller to adjust a fill limit of the second tank in response to a first fuel level in the first tank. A third example of the fuel system, optionally including one or more of the previous examples, further includes where the fill limit of the second tank is decreased in response to the first fuel level being less than a threshold first fuel level. A fourth example of the fuel system, optionally including one or more of the previous examples, further includes where the threshold first fuel level is equal to a fill limit of the first tank. A fifth example of the fuel system, optionally including one or more of the previous examples, further includes where the threshold first fuel level is equal to a fill height of the first fuel configured to submerge the second tank. A sixth example of the fuel system, optionally including one or more of the previous examples, further includes where the threshold first fuel level is based on one or more of a current first fuel temperature, a current second fuel level, and a second tank temperature. A seventh example of the fuel system, optionally including one or more of the previous examples, further includes where the first tank comprises a first fuel inlet configured to admit the first fuel to only the first tank and a first fuel outlet configured to expel only the first fuel from the first tank, and wherein the second tank comprises a second fuel inlet configured to admit the second fuel to only the second tank and a second fuel outlet configured to expel only the second fuel from the second tank.

The disclosure provides additional support for a fuel system for a mobile asset including a gaseous fuel tank comprising a gaseous fuel is arranged in an interior volume of a liquid fuel tank comprising a liquid fuel, wherein the gaseous fuel tank is sealed from and in contact with the liquid fuel. A first example of the fuel system further includes a controller with instructions stored on memory that when executed enable the controller to adjust a refueling of the gaseous fuel tank in response to a level of the liquid fuel in the liquid fuel tank. A second example of the fuel system, optionally including the first example, further includes where the instructions further enable the controller to determine a degradation of the gaseous fuel tank in response to a presence of the gaseous fuel in a vapor of the liquid fuel. A third example of the fuel system, optionally including one or more of the previous examples, further includes where the gaseous fuel tank is submerged in the liquid fuel and mounted to interior surfaces of the liquid fuel tank. A fourth example of the fuel system, optionally including one or more of the previous examples, further includes an active cooling system configured to flow the liquid fuel around an exterior of the gaseous fuel tank.

In one embodiment, the control system, or controller, may have a local data collection system deployed and may use machine learning to enable derivation-based learning outcomes. The controller may learn from and make decisions on a set of data (including data provided by the various sensors), by making data-driven predictions and adapting according to the set of data. In embodiments, machine learning may involve performing a plurality of machine learning tasks by machine learning systems, such as supervised learning, unsupervised learning, and reinforcement learning. Supervised learning may include presenting a set of example inputs and desired outputs to the machine learning systems. Unsupervised learning may include the learning algorithm structuring its input by methods such as pattern detection and/or feature learning. Reinforcement learning may include the machine learning systems performing in a dynamic environment and then providing feedback about correct and incorrect decisions. In examples, machine learning may include a plurality of other tasks based on an output of the machine learning system. The tasks may be machine learning problems such as classification, regression, clustering, density estimation, dimensionality reduction, anomaly detection, and the like. In examples, machine learning may include a plurality of mathematical and statistical techniques. The machine learning algorithms may include decision tree based learning, association rule learning, deep learning, artificial neural networks, genetic learning algorithms, inductive logic programming, support vector machines (SVMs), Bayesian network, reinforcement learning, representation learning, rule-based machine learning, sparse dictionary learning, similarity and metric learning, learning classifier systems (LCS), logistic regression, random forest, K-Means, gradient boost, K-nearest neighbors (KNN), a priori algorithms, and the like. In embodiments, certain machine learning algorithms may be used (e.g., for solving both constrained and unconstrained optimization problems that may be based on natural selection). In an example, the algorithm may be used to address problems of mixed integer programming, where some components are restricted to being integer-valued. Algorithms and machine learning techniques and systems may be used in computational intelligence systems, computer vision, Natural Language Processing (NLP), recommender systems, reinforcement learning, building graphical models, and the like. In an example, machine learning may be used for vehicle performance and control, behavior analytics, and the like.

In one embodiment, the controller may include a policy engine that may apply one or more policies. These policies may be based at least in part on characteristics of a given item of equipment or environment. With respect to control policies, a neural network can receive input of a number of environmental and task-related parameters. The neural network can be trained to generate an output based on these inputs, with the output representing an action or sequence of actions that the engine system should take. This may be useful for balancing competing constraints on the engine. During operation of one embodiment, a determination can occur by processing the inputs through the parameters of the neural network to generate a value at the output node designating that action as the desired action. This action may translate into a signal that causes the engine to operate. This may be accomplished via backpropagation, feed forward processes, closed loop feedback, or open loop feedback. Alternatively, rather than using backpropagation, the machine learning system of the controller may use evolution strategies techniques to tune various parameters of the artificial neural network. The controller may use neural network architectures with functions that may not always be solvable using backpropagation, for example functions that are non-convex. In one embodiment, the neural network has a set of parameters representing weights of its node connections. A number of copies of this network are generated and then different adjustments to the parameters are made, and simulations are done. Once the output from the various models are obtained, they may be evaluated on their performance using a determined success metric. The best model is selected, and the vehicle controller executes that plan to achieve the desired input data to mirror the predicted best outcome scenario. Additionally, the success metric may be a combination of the optimized outcomes. These may be weighed relative to each other.

As used herein, an element or step recited in the singular and preceded with the word “a” or “an” should be understood as not excluding plural of said elements or steps, unless such exclusion is explicitly stated. Furthermore, references to “one embodiment” of the invention do not exclude the existence of additional embodiments that also incorporate the recited features. Moreover, unless explicitly stated to the contrary, embodiments “that includes,” “including,” or “having” an element or a plurality of elements having a particular property may include additional such elements not having that property. The terms “including” and “in which” are used as the plain-language equivalents of the respective terms “that includes” and “wherein.” Moreover, the terms “first,” “second,” and “third,” etc. are used merely as labels, and are not intended to impose numerical requirements or a particular positional order on their objects.

The control methods and routines disclosed herein may be stored as executable instructions in non-transitory memory and may be carried out by the control system including the controller in combination with the various sensors, actuators, and other engine hardware. The specific routines described herein may represent one or more of any number of processing strategies such as event-driven, interrupt-driven, multi-tasking, multi-threading, and the like. As such, various actions, operations, and/or functions illustrated may be performed in the sequence illustrated, in parallel, or in some cases omitted. Likewise, the order of processing is not necessarily required to achieve the features and advantages of the example embodiments described herein, but is provided for ease of illustration and description. One or more of the illustrated actions, operations and/or functions may be repeatedly performed depending on the particular strategy being used. Further, the described actions, operations and/or functions may graphically represent code to be programmed into non-transitory memory of the computer readable storage medium in the engine control system, where the described actions are carried out by executing the instructions in a system including the various engine hardware components in combination with the electronic controller.

This written description uses examples to disclose the invention, including the best mode, and also to enable a person of ordinary skill in the relevant art to practice the invention, including making and using any devices or systems and performing any incorporated methods. The patentable scope of the invention is defined by the claims, and may include other examples that occur to those of ordinary skill in the art. Such other examples are intended to be within the scope of the claims if they have structural elements that do not differ from the literal language of the claims, or if they include equivalent structural elements with insubstantial differences from the literal languages of the claims.

1. A system, comprising:
a first fuel arranged in an interior volume of a first tank; and
a second fuel arranged in an interior volume of a second tank, the second tank arranged in the interior volume of the first tank and in contact with the first fuel.

2. The system of claim 1, wherein the second tank is hermetically sealed from the interior volume of the first tank.

3. The system of claim 1, wherein the second tank is submerged in the first fuel.

4. The system of claim 1, wherein the first fuel is a liquid fuel and the second fuel is a gaseous fuel.

5. The system of claim 1, further comprising a cooling system configured to cool the second tank via the first fuel.

6. The system of claim 1, wherein the second fuel is a cryogenic liquid or a solid fuel.

7. The system of claim 1, wherein the first fuel is different than the second fuel, and wherein the first fuel and the second fuel comprise two of diesel, hydrogenation-derived renewable diesel (HDRD), biodiesel, syn-gas, alcohol, gasoline, kerosene, ether, natural gas, ammonia, and hydrogen.

8. A fuel system, comprising
a first fuel arranged in an interior volume of a first tank;
a second fuel arranged in an interior volume of a second tank, the second tank arranged in the interior volume of the first tank and in contact with the first fuel;
a vent valve coupled to the interior volume of the first tank, wherein a second fuel sensor is coupled to the vent valve and configured to sense a concentration of the second fuel in vapors of the first fuel; and
a controller with instructions stored on memory thereof that when executed cause the controller to:
determine a condition of the second tank the concentration of the second fuel in vapors of the first fuel.

9. The fuel system of claim 8, wherein the condition is the second tank is degraded in response to the concentration being greater than a threshold concentration.

10. The fuel system of claim 8, wherein the instructions further cause the controller to adjust a fill limit of the second tank in response to a first fuel level in the first tank.

11. The fuel system of claim 10, wherein the fill limit of the second tank is decreased in response to the first fuel level being less than a threshold first fuel level.

12. The fuel system of claim 11, wherein the threshold first fuel level is equal to a fill limit of the first tank.

13. The fuel system of claim 11, wherein the threshold first fuel level is equal to a fill height of the first fuel configured to submerge the second tank.

14. The fuel system of claim 11, wherein the threshold first fuel level is based on one or more of a current first fuel temperature, a current second fuel level, and a second tank temperature.

15. The fuel system of claim 8, wherein the first tank comprises a first fuel inlet configured to admit the first fuel to only the first tank and a first fuel outlet configured to expel only the first fuel from the first tank, and wherein the second tank comprises a second fuel inlet configured to admit the second fuel to only the second tank and a second fuel outlet configured to expel only the second fuel from the second tank.

16. A fuel system for a mobile asset, comprising:
a gaseous fuel tank comprising a gaseous fuel is arranged in an interior volume of a liquid fuel tank comprising a liquid fuel, wherein the gaseous fuel tank is sealed from and in contact with the liquid fuel.

17. The fuel system of claim 16, further comprising a controller with instructions stored on memory that when executed enable the controller to adjust a refueling of the gaseous fuel tank in response to a level of the liquid fuel in the liquid fuel tank.

18. The fuel system of claim 17, wherein the instructions further enable the controller to determine a degradation of the gaseous fuel tank in response to a presence of the gaseous fuel in a vapor of the liquid fuel.

19. The fuel system of claim 16, wherein the gaseous fuel tank is submerged in the liquid fuel and mounted to interior surfaces of the liquid fuel tank.

20. The fuel system of claim 16, further comprising an active cooling system configured to flow the liquid fuel around an exterior of the gaseous fuel tank.
